(19) United States
(12) Patent Application Publication
(10) Pub. No.: US 2008/0218411 A1
(43) Pub. Date: Sep. 11, 2008

(54) Assisted Satellite-Based Positioning

(75) Inventors: Karl Torbjorn Wigren, Uppsala (SE); Torgny Palenius, Barseback (SE)

Correspondence Address: NIXON & VANDERHYE, PC, 901 NORTH GLEBE ROAD, 11TH FLOOR, ARLINGTON, VA, 22203, US

(73) Assignee: TELEFONAKTIEBOLAGET LM ERICSSON (PUBL), Stockholm (SE)

(21) Appl. No.: 11/630,262

(22) PCT Filed: Jun. 29, 2004
(86) PCT No.: PCT/SE04/01054

§ 371 Date: Nov. 13, 2007

(51) Int. Cl. G01S 1/00

(52) U.S. Cl. 342/357.15; 342/357.1

(57) ABSTRACT

One upper and one lower bound on the search window for the code phase of a signal transmitted from a specific satellite (20) can be computed for terminals (10) that reside anywhere in a closed region (41), having a non-circular symmetry, obtained by an initial positioning step. A position is then determined using search windows having such upper and such lower bound for at least one satellite (20). The upper and lower bounds are provided using satellite position data in three dimensions (r, φ, Θ) satellite time reference data as well as geometric information about the closed region (41) of the initial positioning.

### TECHNICAL FIELD

The present invention relates in general to positioning of mobile equipment by use of satellites and in particular to such positioning assisted by land based communication nodes.

### BACKGROUND

In recent years, determination of the geographic position of an object, equipment or a person carrying the equipment has become more and more interesting in many fields of application. One approach to solve the positioning is to use signals emitted from satellites to determine a position. Well-known examples of such systems are the Global Positioning System (GPS) and the GLObal NAvigation Satellite System (GLONASS), see e.g. [1]. The position is given with respect to a specified coordinate system as a triangulation based on a plurality of received satellite signals.

A stand-alone GPS receiver can obtain full locking to GPS satellite signals, without having any other information about the system except nominal carrier frequency and the rules by which data carried by the signals are modulated. Basically, the three-dimensional position as well as a receiver clock bias to the satellite time have to be determined in the position calculation step. However, such a start-up procedure from basically no prior information at all takes time and requires typically large computational efforts. By increasing the initial knowledge of the system, the locking procedure can be speeded up and simplified. Assisted GPS (A-GPS) technology is an enhancement of GPS, where additional information can be provided to the GPS receiver in order to facilitate the locking-on procedures. If the GPS receiver is connected to a cellular communications system, additional assistance data can be collected from the cellular communication system directly. This typically enables a rough initial estimate of the position of the receiver together with a corresponding uncertainty of the initial estimate. Furthermore, information about the approximate satellite system reference time as well as information about which satellites that are above the horizon can be provided.

When satellite signals are acquired, see e.g. [2], acquisition has to be performed in a carrier dimension, handling different Doppler shifts, as well as in a code (or range) dimension. Searching the entire carrier-code space for acquiring the satellite signal is a time-consuming process. Fine time assistance means that the GPS receiver is provided with highly accurate information related to the global GPS time and satellite positions in space. Any assistance data that might reduce the search window size will improve the process.

In the U.S. Pat. No. 6,429,815, a method and an apparatus for determining search centre and size in searches for transmissions from GPS satellites is disclosed. In a particular well defined situation, where the distribution of the position of the mobile terminal has a circular symmetry centred around a base station, a search window centre and search window size that is optimal for that particular situation can easily be determined by simple relations. The disclosure further states a wish or an assumption that further wireless communications system data can be used to further refine the definition of the search window. However, since such data removes the circular symmetry of the particular situation previously discussed, the described approach in connection with this can not be applied on cases further relying on this kind of data. Moreover, no further description of how to enable anyone skilled in the art to perform such refining of the search window based on such wireless communications system data is given.

It is thus since long known from prior art that there is a pronounced need for improving the search window position and/or size upon GPS positioning, but no general solutions are publicly available within prior art.

### SUMMARY

A general object of the present invention is to provide improved methods and devices for satellite based positioning with assistance data. A further object with the present invention is to reduce the computational efforts needed for obtaining code phases of signals transmitted from satellites. Yet a further object is to optimally reduce a search window based on available assistance data even in non-symmetry situations.

The above objects are achieved by methods and devices according to the enclosed patent claims. In general words, one upper and one lower bound on the code phase of a signal transmitted from a specific satellite can be computed for terminals that reside anywhere in a closed region, having a non-circular symmetry, obtained by an initial positioning step. A position is then determined using search windows having such upper and such lower bound for at least one satellite. The upper and lower bounds are provided using satellite position data in three dimensions, satellite time reference data as well as geometric information about the closed region of the initial positioning. If the location where the satellite time reference data is provided is located within the closed region, the search window lower limit is preferably determined to be equal to an estimated code phase shift at that location minus an uncertainty of the satellite time reference data. If the location where the satellite time reference data is provided is located outside the closed region, the search window lower limit is preferably determined to be equal to the minimum estimated code phase shift at the boundary of the closed region minus an uncertainty of the satellite time reference data. The search window upper limit is preferably determined to be equal to the maximum estimated code phase shift at the boundary of the closed region plus an uncertainty of the satellite time reference data.

The invention also discloses devices and arrangements for performing the above procedures.

An advantage of the present invention is that the computational complexity in satellite-based positioning is reduced regardless of the system symmetry. The reduced complexity can be utilised to enhance the positioning sensitivity or to reduce the power consumption during the positioning or a combination thereof.

### BRIEF DESCRIPTION OF THE DRAWINGS

The invention, together with further objects and advantages thereof, may best be understood by making reference to the following description taken together with the accompanying drawings, in which:

FIG. 1 is a block diagram of a satellite positioning system;

FIG. 2 is an illustration of coordinate systems used for positioning purposes;

FIG. 3 is an illustration of relative positions used during satellite positioning;

FIG. 4a is a diagram illustrating the relation between GPS time and cellular frame times experienced at different positions in a system;

FIG. 4b is a diagram illustrating the relation between GPS time and GPS frame times experienced at different positions in a system;

FIG. 5 is an illustration of closed areas serving as initial coarse positioning areas;

FIG. 6 illustrates a WCDMA system having a polygon defining a closed area in which a mobile terminal is situated;

FIG. 7A is a block diagram of an embodiment of an arrangement according to the present invention;

FIG. 7B is a block diagram of a similar embodiment as in FIG. 7A, but with a distributed reference node;

FIG. 8 is a block diagram of another embodiment of an arrangement according to the present invention;

FIG. 9 is a block diagram of yet another embodiment of an arrangement according to the present invention;

FIG. 10 is a block diagram of yet another embodiment of an arrangement according to the present invention;

FIG. 11 is a flow diagram of the main steps of an embodiment of a method according to the present invention;

FIG. 12 illustrates definitions used in evaluating necessary search window sizes;

FIG. 13 illustrates a cell polygon used as an example of a closed area;

FIG. 14 is a three-dimensional diagram illustrating variations in code phases within the polygon of FIG. 13 with an interior base station; and

FIG. 15 is a three-dimensional diagram illustrating variations in code phases within the polygon of FIG. 13 with an exterior base station.

### DETAILED DESCRIPTION

In the detailed description below, embodiments implemented in a GPS system are illustrated. However, anyone skilled in the art realises that the corresponding principles can be applied in any satellite based positioning system, such as the GLONASS or the coming European Galileo satellite navigation system.

Likewise, in the detailed description below, WCDMA systems will be used as model systems. However, the present invention is also applicable on other wireless communications systems. Non-exclusive examples of other systems on which the present invention are e.g. the CDMA-2000 system or the GSM system. When applied to other wireless communications systems, the implementation of the different functionalities will be done in different terminals and nodes of such systems.

The term “mobile terminal” is in the present disclosure used to denote any kind of terminal that can be transported within a wireless communications system. Non-exclusive examples are telephones, personal digital assistants and portable computers.

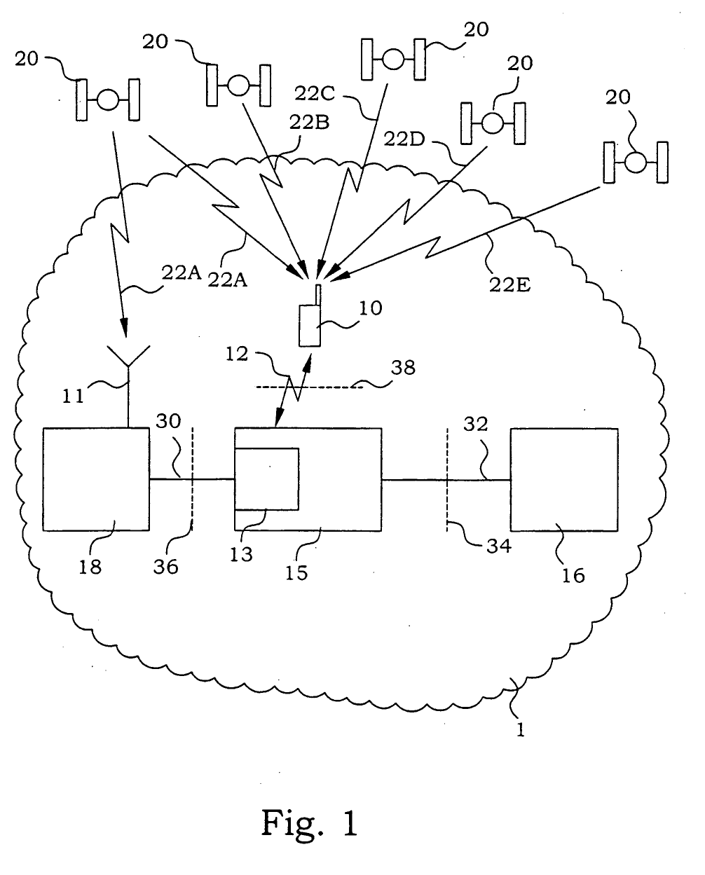

FIG. 1 illustrates a wireless communications system 1, in this particular example a WCDMA system, in which a position of a mobile terminal 10 or of the person carrying the mobile terminal 10 can be determined by using signals 22A-E emanating from space vehicles 20, i.e. typically satellites. The positioning procedures are in this example assisted by additional data provided from a reference receiver 18 connected to the communications system. The reference receiver 18 is locked to the emitted signals 22A-E from all visible satellites 20, which signals 22A-E the antenna 11 receives. (The figure only illustrate one such received signal 22A.) The received signal 22A carries data that can be used as assistance data, which is useful for positioning also of other devices. When transmitted to the receiver in the mobile terminal 10, it may therefore enhance the performance of the terminal receiver. The locking to the satellite signal provides knowledge of a satellite time reference, defining the timing of the emission of the ranging signals. This timing definition is typically performed by referring to a frame time reference used by the cellular communications system, in which the mobile terminal is used. The reference receiver 18 therefore has to be provided with accurate information about the frame time reference used by the cellular communications system. This means that at least a part of the reference receiver 18 has to be a part of the node creating the cellular frame structure, i.e. typically a radio base station, or to be listening or experiencing the cellular frame structure and its timing properties. As discussed further below, the reference receiver 18 can be provided as one unit or divided in parts, thereby separating the determination of the satellite time reference and the satellite position data discussed below.

The received data 22A-E from the satellites 20 also comprise ephemeris data, i.e. among other things a satellite orbit prediction. It is also possible to use the so-called GPS almanac, which also provides a basis for determining satellite positions. Assistance data 30, comprising satellite position data and satellite time reference data, is in this particular example sent over a reference receiver interface 36 to a Radio Network Controller (RNC) 15. A satellite positioning interface 13 receives this data and may e.g. determine which satellites might be in such positions that their ranging signals 22A-E are probable to detect.

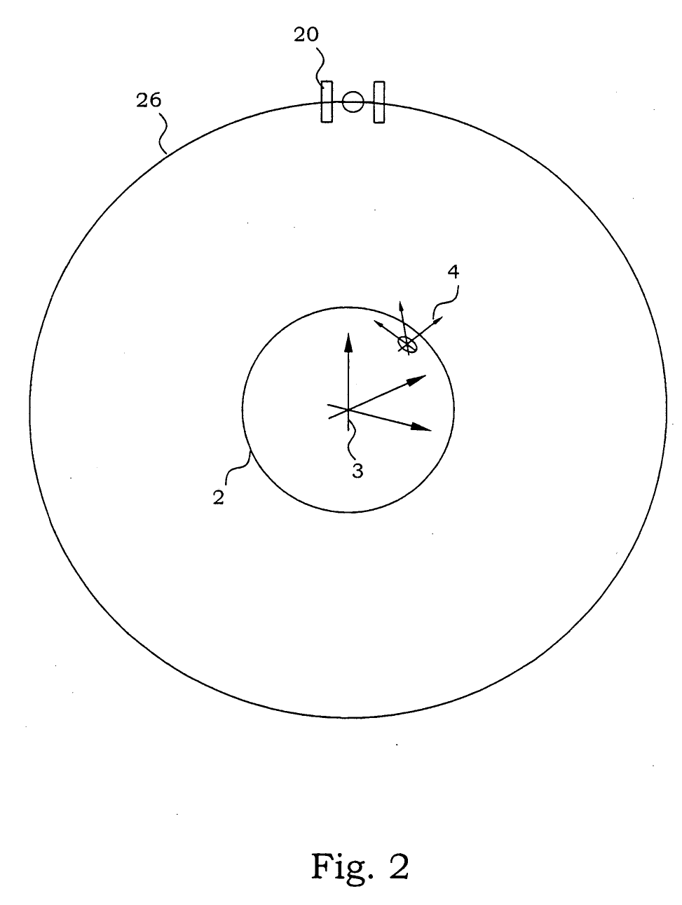

When a positioning request occurs, e.g. in a core network 16 of the communications system 1, the positioning request 32 is provided to the RNC over a RANAP interface 34 (Radio Access Network Application Part). In an alternative embodiment, an external positioning node could be connected to the RNC, e.g. over an Iupc interface. The Iupc interface is a logical interface for the interconnection of standalone A-GPS SMLC (Serving Mobile Location Center) and RNC components of the UTRAN (Universal Terrestrial Radio Access Network) for an UMTS system, see e.g. [4]. The RNC creates control signalling ordering measurements of satellite ranging signals 22A-E and sends the control signals 12 over a RRC interface 38 (Radio Resource Control interface) to the mobile terminal 10. The measurement order is accompanied by assistance data, typically processed in the satellite positioning interface 13. The mobile terminal 10 is equipped with a receiver that is capable of detecting satellite ranging signals 22A-E and the mobile terminal 10 uses the assistance data to facilitate the locking on and measuring of the satellite ranging signals 22A-E. The measured ranging signals are then used to calculate a position of the mobile terminal 10 according to standard satellite positioning procedures. If user equipment based A-GPS is used, the processing of the ranging signals is performed in the mobile terminal. If user equipment assisted A-GPS is used, the ranging signals or representations thereof are sent to the RNC, where the processing for purposes of positioning is performed. The use of fine time assistance data allows the satellite receiver of the mobile terminal 10 to obtain the best sensitivity possible. Fine time assistance data is a relatively vague expression. The meaning of fine time assistance in the present disclosure is time reference assistance having an accuracy typically in the order of some tens of microseconds. The order of magnitude of the accuracy has to be considerably less than the GPS C/A (Coarse/Acquisition) epoque, which has a duration of 1 ms, if GPS is used. The coordinates used in satellite positioning systems, and in particular GPS, are normally based on an earth centred coordinate system. FIG. 2 illustrates schematically the earth 2 and a coordinate system 3 based at the centre of the earth, e.g. the WGS 84 earth model. An orbit 26 and a present position of a satellite 20 can be expressed in WGS 84 coordinates. This is done by using the present satellite system reference time and the ephemeris information about the available satellites. The satellite system reference time can continuously be updated by reference receivers. Position determination of mobile terminals is based on measurement of a number of ranging signals from satellites. However, when making such calculations, mobile terminal positions and satellite positions may typically be transferred to an earth tangential coordinate system 4. Such a system is typically centred in the vicinity of the position to be determined, e.g. the radio base site coordinates is one good alternative. The coordinate system normally has one axis pointing north, one pointing east, and one pointing up. An earth tangential Cartesian coordinate system is then suitable for expressing the position of the mobile terminal as well as satellite positions.

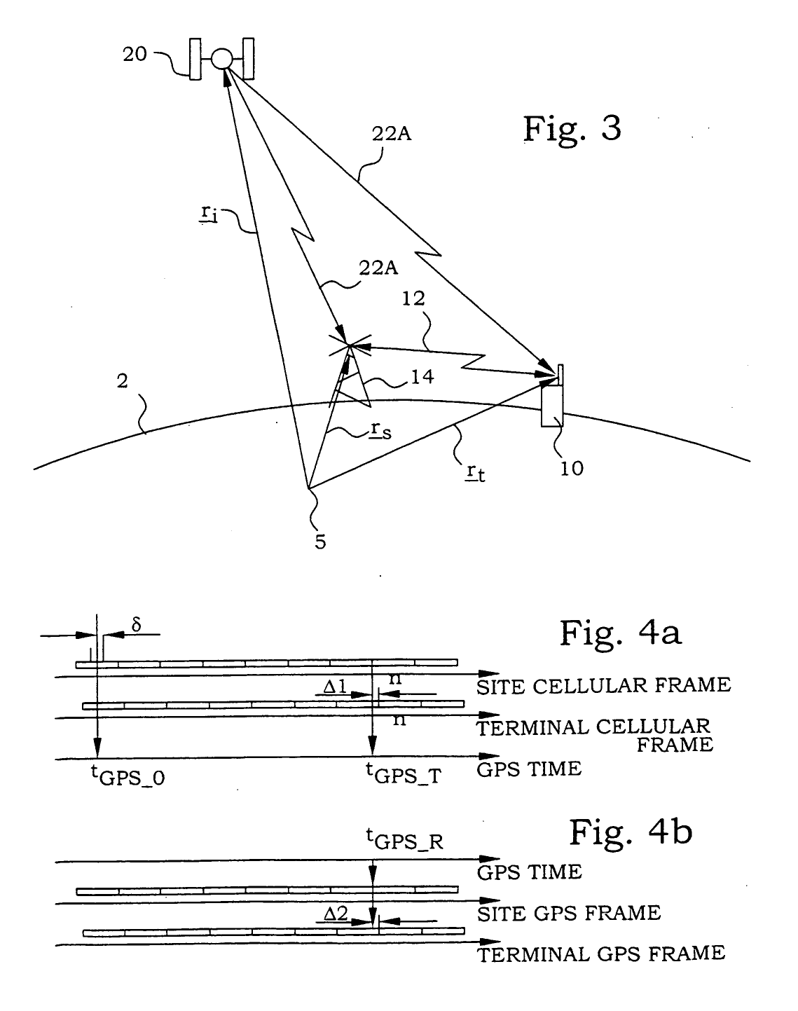

FIG. 3 illustrates a situation where an earth tangential coordinate system is based at the point denoted by 5. A vector rᵢ defines the position of a radio base station 14, a vector rᵢ denotes the unknown position of the mobile terminal 10 and a vector rᵢ denotes the present position of a satellite 20 number i in the earth tangential coordinate system. The satellite 20 emits a ranging signal 22A-E, which is received by a reference node, typically at the radio base station and by the mobile terminal, respectively. The signal is emitted at a specific time according to the satellite time, and the time it takes for the signal to reach the receivers corresponds to the distance or range it travels. By determining the travelling time, the distance can also be determined. Furthermore, if signals 12 are sent from the base station to the mobile terminal, their relative distance may also be determined by obtaining the travelling time for the signal.

GPS is a code division multiple access (CDMA) system. The GPS signal from each satellite is hence associated with a specific code. The chip rate of this code being 1.023 MHz for the civil coarse acquisition (C/A) signal. The signal from each satellite is retrieved by correlation against the unique code of each satellite. This code has a duration of 1023 chips (exactly 1 millisecond). A further complication is now that a 50 Hz bit stream is superimposed on the GPS ranging signals from the satellites. These GPS message bits contain information that the GPS receiver would have needed in order to calculate its position in case that assistance data would not be available from the cellular communications system. The bit edges complicate ranging correlations since the unknown switches of sign at the bit edges deteriorate correlation receiver performance in case the exact time instances of the bit edges are not known. Until accurate synchronisation to GPS time has been established in the GPS receiver, coherent correlation over more than 10 milliseconds is hence not possible. This fact reduces performance significantly when the first satellite is acquired since the assisted GPS receiver sensitivity is reduced with 5-10 dB since incoherent correlation needs to be used. The remaining satellites do not suffer from this sensitivity loss since they can exploit the synchronisation to GPS time obtained as a consequence of the detection of the first satellite. To conclude, the first and most important benefit of fine time assistance is that it allows the assisted GPS receiver to apply coherent correlation detection also for the first satellite it acquires.

Other advantages associated with fine time assistance is that it allows the correlation search window to be reduced in the code dimension more than a factor of 10 as compared to the complete 1023 chips code epoch of the GPS ranging signal. GPS correlation receivers search a two-dimensional code and Doppler space due to the large variation of the relative speeds of the satellites. This search window reduction results in an additional assisted GPS sensitivity improvement since there are less code and Doppler search bins that can result in false alarms of the receiver. This gain is however relatively small. Calculations indicate that it is of the order of 0.1-0.5 dB depending on the assumptions. More importantly, the reduced search window sizes reduce the computational complexity of the GPS receiver proportionally, a fact that translates into the possibility to correlate for longer periods of time to enhance sensitivity, or to reduce the computation time, thereby also reducing the power consumption. The latter benefit may be substantial in cases where the assisted GPS receiver is used for satellite acquisition purposes during extended periods of time. Note that the benefit of a reduced search window is always present when new and undetected satellites are searched for.

The present invention relates to the determination of the search window used in the code and Doppler correlation search step in order to achieve an always optimised window alignment so that search windows of minimal size can be used in the GPS signal acquisition. This information can also be used to select the first satellite to search for when establishing GPS time, so that the best achievable GPS receiver sensitivity is obtained for this satellite.

In order to determine a distance between a receiver and a satellite, the receiver has to have knowledge about the time instant when the transmitter transmitted the signal. In a system having access to assistance data, an approximate system time can be provided. However, since the mobile terminal to be positioned typically is placed at a distance from the node providing the time difference, durations for transferring time references have to be compensated.

In FIG. 4a, a time diagram is drawn, illustrating three time scales, one time reference scale for the satellite system, in this example a GPS system, one time scale for a site, typically a base station, providing assistance data and one time scale for the mobile terminal. This description is based on the use of a time stamping GPS receiver in the serving radio base station. A time t_{GPS}_{_{—}}ₒ is defined as a present time of the GPS system. It is assumed that the accuracy associated with this time stamping in the radio base station is δ seconds. The GPS time is defined globally, i.e. it is a time standard where the time has the same value at all places in the world. Using the internal clock of the cellular communications system, the time until a specified future event, in this example the start of the n:th future cellular data frame, can be determined. A transformation to GPS time results in a time t_{GPS}_{_{—}}ᵣ, corresponding to the start time of the n:th cellular data frame sent after t_{GPS}_{_{—}}ₒ. The future frame event needs to be selected with such a large advance that the frame event to GPS time relation information is allocated enough time for transmission from the cellular communication system to the terminal.

The receiving terminal time scale is as seen in FIG. 4a displaced from the site time scale by a time amount Δ1 introduced by the time of propagation of radio signals of the cellular communication system when these waves propagate from the radio base station to the mobile terminal along the surface of the earth. As a result, the start of frame n of the cellular communication system will be delayed as compared to the GPS time. This amount of time variation equals the unknown distance between the radio base station site and the mobile terminal, divided by the speed of light.

There are also other alternatives than time stamping. One such alternative that is under discussion is to use the terminals to determine the relation between GPS time (code phase) and a defined, periodically repeated, transmission instant of the cellular communication systems ordinary transmission. Terminals of opportunity that perform assisted GPS positioning would then report this information to the cellular communications system for further distribution to other users.

The principles above are intended to allow a GPS receiver of a mobile terminal to make an alignment of correlation search windows and measured GPS signals in the best way possible. The satellite signals of each GPS satellite are retrieved by correlation against a unique code. Since the position of the mobile terminal is not known exactly to the GPS receiver, an additional effect affects the search window alignment with respect to the received signal from each GPS satellite. Briefly, the unknown location of the terminal implies that the GPS code phase received in the GPS receiver of the terminal may be early or late with respect to what is experienced in the reference site, e.g. the radio base station. FIG. 4b illustrates such a situation. A reference site has knowledge of the code phase of the received signal from the satellite at the GPS time t_{GPS}_{_{—}}_{R}, e.g. at the start of a GPS frame. However, when measured in the mobile terminal, the code phase, e.g. the start of the GPS frame, will differ an amount Δ2.

It is now clear that the distribution of fine GPS time assistance, e.g. by using the frame structure of the cellular communications system, will introduce variations when aligning GPS code phase search windows of terminals to the cellular communication system. It is a request to reduce the size of the search window as much as possible, since the computational effort scale proportionally to the search window size.

In the U.S. Pat. No. 6,429,815, a particular situation is considered in detail, where there is additional information available about the distance between the mobile terminal and the radio base station. In other words, the time difference Δ1 is known, and the mobile terminal is situated somewhere at a circle centred at the base station. With such geometry, also the estimation of the possible extremes of Δ2 becomes simple. Since an entire circle is considered, there are always two points at the circle that are situated in the same vertical plane as the satellite and the base station. These two points correspond to the two extreme cases of Δ2, and can easily be calculated being dependent on the cosine of the satellite elevation.

However, when the circular symmetry is broken and/or the uncertainty of the distance between the mobile terminal and the base station is relatively large, such reasoning is not applicable. It can be shown that with non-circular symmetry of the area in which the mobile terminal can be located, the necessary minimum search window can vary considerably. Examples are shown in Appendix 1. It is not obvious from any prior art and in particular not from U.S. Pat. No. 6,429,815 how a general minimisation valid for any shape or size of the area in which the mobile terminal can be located is to be carried out.

In the present invention, the search window used in the code and Doppler correlation search step for the registered satellite ranging signal is determined by using information of e.g. cell geometry or other initial position information together with calculated satellite positions. This allows an optimised search window alignment so that the search window of minimal size can be used in the GPS signal acquisition. The optimised search window is achieved by finding a search window lower limit that is as high as possible, but still ensured to be less than or equal to the actual code phase shift for the registered satellite ranging signal. Similarly, a search window upper limit is found, which is as low as possible, but still ensured to be larger than or equal to the actual code phase shift for the registered satellite ranging signal.

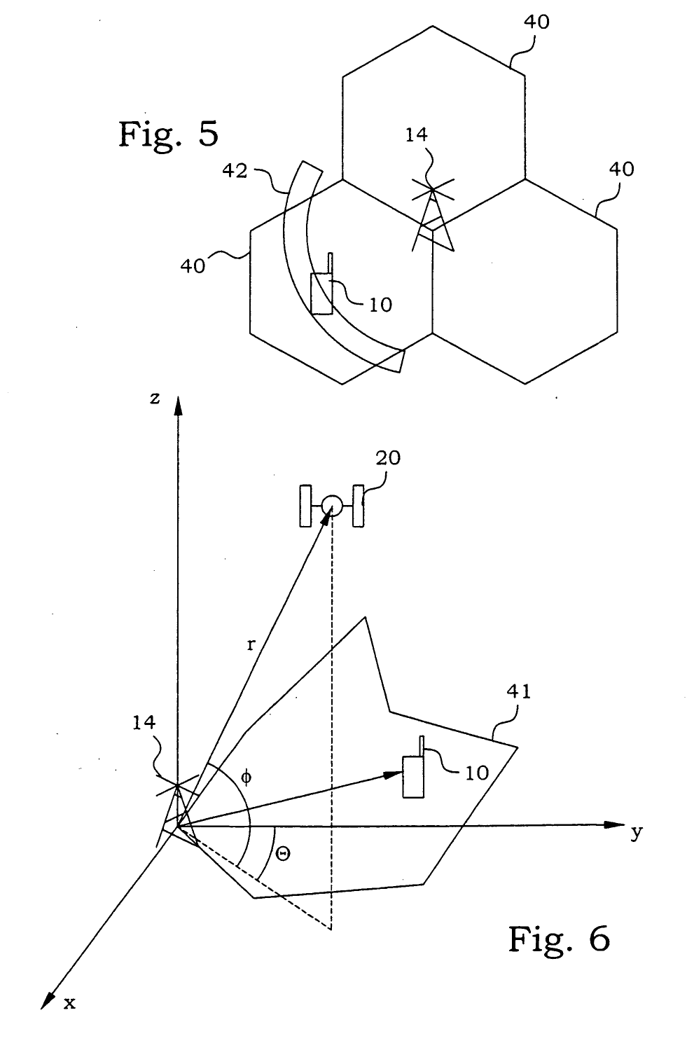

Additional assistance data is collected from the cellular communication system directly, typically to obtain a rough initial estimate of the position of the terminal together with a corresponding uncertainty of the initial estimate. This position is often given by a so-called cell identity positioning step, i.e. the position of the terminal is determined with cell granularity. This is schematically illustrated in FIG. 5. In such a cell identity positioning step, the position of the mobile terminal 10 is determined to be within a closed polygon 40 that model the cell extension. In WCDMA the cell identity position is reported in terms of a 3-15 corner polygon, where the corners are given in terms of WGS 84 latitude and longitude pairs.

Alternatively, a more accurate position can be obtained by measuring the travel time of radio waves from the serving radio base station 14 to the terminal 10 and back, thereby establishing a region 42 at a certain approximate distance from the serving radio base station 14 where the mobile terminal 10 must be located. In WCDMA this is denoted round trip time (RTT) positioning. The result of the positioning is reported in terms of an arc 42 with the centre in the serving radio station 14 site coordinates. The thickness of the arc 42 is due to measurement uncertainties. If the thickness of the arc 42 is large compared to the required final positioning accuracy or if the arc 42 is smaller than 360 degrees, prior art methods for determining search windows can not be applied to provide an optimum search window.

In FIG. 6, a more general WCDMA case is illustrated. A mobile terminal 10 is situated within a closed area 41, defined as a polygon having a number of corners. The base station 14 can be situated within the closed area 41, outside the closed area 41 or at the rim. A satellite 20 is situated at a position defined by three coordinates, e.g. (x,y,z) in a Cartesian coordinate system or (φ,Θ,r) in a polar coordinate system. In FIG. 6, one realises that estimating a proper optimised search window, the three-dimensional position of the satellite 20 has to be taken into account, not only the elevation angle φ.

As mentioned above, an initial determination of the closed area within which the mobile terminal is situated is performed. In a particular embodiment, the closed area is a cell polygon that describes the extension of the cell. The coordinate system is normally based on the WGS84 earth model and polygon corners are usually given as a list of latitude, longitude values that comprise the coordinates of each corner of the polygon.

Satellite ephemeris data and satellite time information are then collected from a reference node. Ephemeris data for the GPS system is described in e.g. [3]. Using ephemeris information, the position of all satellites can be computed in the WGS 84 earth centred coordinates, using the present updated satellite system time. The corners of the cell polygon and the position of the satellites may be transferred to an earth tangential coordinate system, typically centred somewhere in the cell in question, as discussed earlier in connection with FIG. 2.

In a particular embodiment, a number of test points to be used for the calculation of the search windows are spread out in the closed area where the mobile terminal is known to be located initially. In case the initial positioning step resulted in a cell polygon, the test points are selected on the cell polygon boundary, including the corner points. This is due to the fact that only points on the polygon boundary or at the radio base station site are relevant in the determination of the search windows. This is formally proven in Appendix 2. In practice a finite number of test points may be spread out along the boundary of the region. An important consequence of this is, however, that the complexity of the calculations is reduced significantly, as compared to a search extending also over the interior of the closed area. These test points represent tentative terminal positions that are to be tested for the satellite ranging signal arrival time from each satellite, as discussed further below. The set of test points is denoted {rᵢ^{TEST}}_{i⊃I}^{N}. Note that the above is true for all geometries, i.e. also for the circular arc, the test points need only be spread out on the actual boundary. One may conjecture that the number of possible points could be refined further to only include the corners of the polygon.

The next step comprises a calculation of lower and upper limits on the satellite code phase experienced by terminals in the closed area, and in the present embodiment, these limits are calculated using the test points. Towards that end it is noted that the total code phase variation that needs to be accounted for is the sum of three terms as follows:

ΔΦ=ΔΦ_{TimeStamp}+ΔΦ_{Cellular Propagation}+ΔΦ_{GPS Propagation}.

Here the first term represents the uncertainty caused by the time stamping of the (future) cellular frame event in the serving radio base station. The first term has a size limited as follows (c.f. FIG. 4a):

|ΔΦ_{TimeStamp}|≦δ

as expressed in GPS C/A code chips. The second term affects the uncertainty in frame start as explained by FIG. 4a. It can be expressed mathematically as

$${ΔΦ}_{Cellular Propagation} = \frac{1}{c} ‖ {r}_{t} - {r}_{s} ‖ {\dot{Φ}}_{GPS}$$

where c denotes the speed of light, Φ_{GPS} denotes the GPS C/A code chip rate, rᵢ denotes the vector pointing to the terminal location, rₛ denotes the vector pointing to the radio base station site and where ∥ ∥ denotes the Euclidian length of a vector (i.e. normal distance). Note that rᵢ is not known, the procedure of the invention rather aims at minimising search windows using the fact that rᵢ is somewhere within a pre-determined area. The third term reflects the effect of FIG. 4b, i.e. the fact that plane waves from the GPS satellites to the terminals may arrive early or late with respect to a reference location close to the cell. Here, the reference location is selected to be the radio base station site coordinates. Note that even if the reference location is different from the radio base station, the relative position is constant and known, which means that anyone skilled in the art may calculate how the situation would be if the reference location would have been placed at the radio base station site instead. The following reasoning will therefore be valid even if the actual reference node location does not coincide with the radio base station location. Note furthermore that this effect due to the third term is highly dependent both on the elevation angle and the azimuth angle of the satellite in question, in the earth tangential Cartesian coordinate system. The third term is given by:

$${ΔΦ}_{GPS Propagation} = ( \frac{1}{c} ‖ {r}_{i} - {r}_{s} ‖ - \frac{1}{c} ‖ {r}_{i} - {r}_{t} ‖ ) {\dot{Φ}}_{GPS} .$$

Here rᵢ denotes the vector that points to the i:th satellite position in the earth tangential coordinate system.

The objective of the invention is now to compute minimal search windows that still guarantee that the actual code phase of the GPS satellites can be found somewhere in the search window. This requires that the following two quantities are determined:

$${max}_{{r}_{i}} ΔΦ$$

$${min}_{{r}_{t}} ΔΦ$$

when rᵢ varies.

The quantity

$${max}_{{r}_{t}} ΔΦ$$

is determined by insertion of all test points {rᵢ^{TEST}}_{i=I}^{N} in the equations for the terms of ΔΦ above, followed by a selection of the point and value that renders the highest value. The test point selection rests on the understanding that the maximum code phase difference is attained on the boundary of the cell polygon, which is valid in all cases where the initial area is a closed polygon area, and in case the distance to the satellites is much larger than the extension of the initial area where the terminal is known to be located. Mathematically, this can be expressed as:

$${max}_{{r}_{t}} ΔΦ = {max}_{{\{ {r}_{t}^{TEST} \}}_{i = 1}^{N}} ΔΦ .$$

The proof behind this is found in Appendix 2.

Note that in the case the closed area is limited by circular arc sections, this alternative can be seen as a limiting case as being defined by a polygon with an infinite number of corners. Hence the result for that case is that

$${max}_{{r}_{t}} ΔΦ$$

is attained on the circular arc boundary.

The quantity

$${min}_{{r}_{t}} ΔΦ$$

is attained in the serving radio base station site coordinates in case these coordinates are in the interior or on the boundary of the cell polygon. Mathematically, this is expressed as:

$${min}_{{r}_{t}} ΔΦ = ΔΦ ( {r}_{t} = {r}_{s} )$$

In case the serving radio base station coordinates are outside of the cell polygon,

$${max}_{{r}_{t}} ΔΦ$$

is attained in a point on the boundary of the cell polygon, i.e.:

$${max}_{{r}_{t}} ΔΦ = {max}_{{\{ {r}_{i}^{TEST} \}}_{i = 1}^{N}} ΔΦ .$$

A proof for this is also given in Appendix 2.

After testing of all boundary test points {rᵢ^{TEST}}_{i=I}^{N}, the following maximising and minimising points
rₘᵢₙ
rₘₐₓ
   result. Using these points the following upper and lower bound on the A-GPS receiver code phase difference as compared to the nominal one corresponding to t_{GPS}_{_{—}}ᵣ can be calculated, exploiting the bound on the first term of ΔΦ

$$max ΔΦ = \frac{1}{c} ‖ {r}_{max} - {r}_{s} ‖ {\dot{Φ}}_{GPS} + ( \frac{1}{c} ‖ {r}_{i} - {r}_{s} ‖ - \frac{1}{c} ‖ {r}_{i} - {r}_{max} ‖ ) {\dot{Φ}}_{GPS} + δ$$

$$min ΔΦ = \frac{1}{c} ‖ {r}_{min} - {r}_{s} ‖ {\dot{Φ}}_{GPS} + ( \frac{1}{c} ‖ {r}_{i} - {r}_{s} ‖ - \frac{1}{c} ‖ {r}_{i} - {r}_{min} ‖ ) {\dot{Φ}}_{GPS} - δ$$

Note that in case the radio base station site is in the interior of the initial region, then

min ΔΦ=−δ

The resulting code phase search window then becomes:

[min ΔΦ, max ΔΦ]

as expressed with respect to the code phase corresponding to t_{GPS}_{_{—}}ᵣ. It is evident that also other representations are possible. In e.g. WCDMA a code phase for each satellite and a corresponding width of the search window are transmitted. The above relations then need to be re-calculated accordingly. Possibly also t_{GPS}_{_{—}}ᵣ would have to be given a fictitious value in order to compensate for any asymmetries in the interval above.

At this point in time it is suitable to mention that there are two types of A-GPS positioning. One type, mobile terminal based A-GPS, performs the positioning calculation in the mobile terminal. The other type, mobile terminal assisted A-GPS performs only ranging measurements in the mobile terminal. The position is calculated in a node of the cellular communication system using the code phases measured in the mobile terminal. In WCDMA, these are denoted UE based A-GPS and UE assisted A-GPS, respectively. The procedure discussed in this disclosure is applicable to both types of A-GPS. The main difference is if the search window alignment is performed in the cellular communications system positioning node or in the mobile terminal. Embodiments of both cases are presented further below. Note that alignment in the terminal can be achieved in case it is provided with fine time assistance as well as in situations where fine time assistance data is not available. In the latter case the mobile terminal has acquired a first GPS satellite and is hence synchronised to the GPS time.

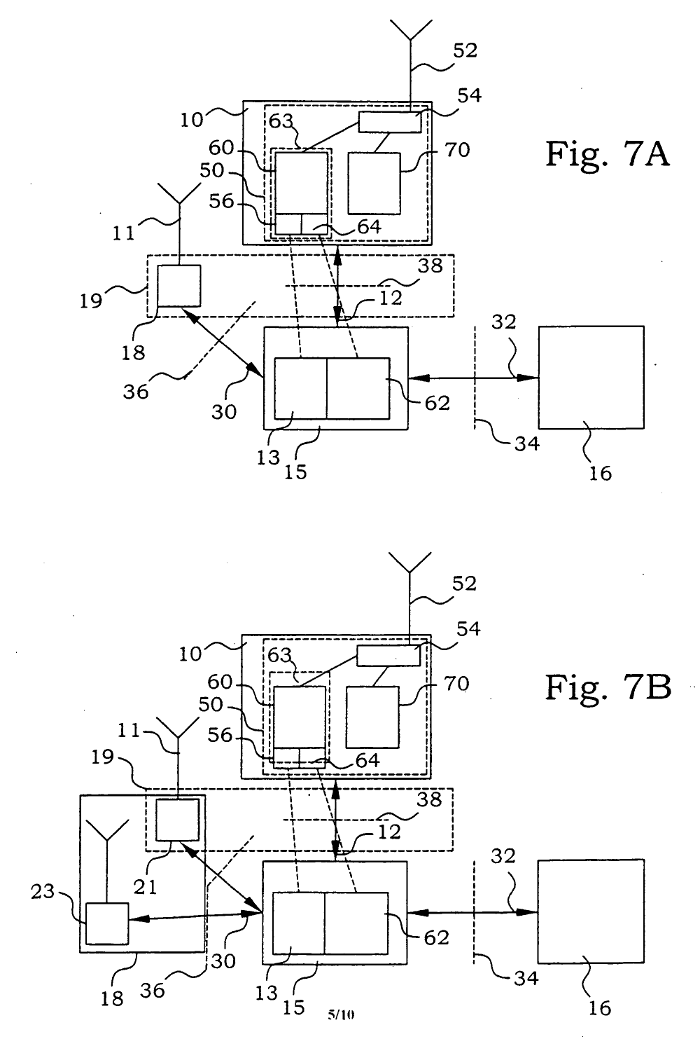

FIG. 7A illustrates an embodiment of a mobile terminal based A-GPS implementation in a WCDMA system. A mobile terminal 10 is connected 12 to a wireless communications network via an RBS (Radio Base Station) 19 and a Radio Network Controller (RNC) 15. Satellite position data and satellite time reference data is provided by a reference satellite node 18, equipped with a satellite signal receiver 11. The reference satellite node 18 is in this particular embodiment comprised in the RBS 19. The satellite position data, e.g. in the form of satellite ephemeris data, and satellite time reference data is communicated to a satellite positioning assistance unit 13 in the RNC 15. In one embodiment, the satellite positioning assistance unit 13 calculates present satellite positions, in three dimensions, for satellites that are candidates for being used for positioning. The satellite position data and satellite time reference data or processed quantities related thereto are in the embodiment of FIG. 7A forwarded to an assistance data receiver unit 56 in the mobile terminal 10.

It is possible to comprise an initial positioning unit 62 in the RNC 15, providing a coarse mobile terminal position in the form of a closed area within which the mobile terminal 10 is known to be present. In one embodiment, this is a cell identity positioning unit, providing the definition of the cell to which the mobile terminal 10 is associated. Such closed area data is provided to a coarse position receiver unit 64 in the mobile terminal 10. Such an embodiment is, however, at the moment not supported by the present WCDMA standard, but is nevertheless easy to implement if necessary.

In an alternative particular embodiment, the initial positioning unit 62 is a unit separated from the RNC 15. The coarse mobile terminal position is then provided to the coarse position receiver unit 64 e.g. comprised in general control signalling data if the initial positioning unit 62 still resides within the communications system itself. The coarse mobile terminal position could also be provided as a data packet sent to the mobile terminal over the data plane. This could e.g. be convenient if the initial positioning unit 62 is not controlled by the communications system operator.

The mobile terminal 10 is now provided with all data necessary for making an optimisation of the search window. This data comprises three-dimensional satellite position data, satellite time reference data and data defining the closed area. The adaptation of the search window to a specific satellite is performed in a processor 60 connected to the means for providing assistance data 56 and coarse terminal position 64. The processor 60, the means for providing assistance data 56 and the coarse position receiver unit together constitute an arrangement 63 for assisting in determining a position for a mobile terminal 10. The adapted search window is then used by a satellite ranging signal registering unit 54, connected to a GPS receiving antenna 52, for obtaining the ranging information from the satellite with minimum efforts. The satellite ranging signal is then utilised for determining a mobile terminal position in a positioning unit 70. Such determining is described in e.g. [5].

The result of the positioning is then typically sent via the RNC to the core network of the communications system. The satellite ranging signal can be combined with other satellite ranging signals or any other positioning information, such as e.g. measured ranges to different radio base stations within the mobile communications network. Such position determination is known as such in prior art and will not be discussed in any details in this disclosure.

From FIG. 7A, it is seen that a positioning node 50 is present within the mobile terminal, comprising e.g. the arrangement 63, the satellite ranging signal registering unit 54, and the positioning unit 70. This is why such an embodiment may be denoted as a mobile terminal based A-GPS configuration.

In FIG. 7A, the reference satellite node 18 was described as one unit, located at the RBS. In FIG. 7B, another embodiment is illustrated, where the reference satellite node 18 comprises two parts. A fine time assistance part 21 is comprised in the RBS 19, while a satellite position assistance part 23 is provided separately. The satellite position assistance part 23 provides satellite position data, e.g. by receiving satellite signals comprising ephemeris data, or simply by retrieving data from another source, e.g. via the Internet. The fine time assistance part 21 has a receiver for satellite signals, which gives a time reference to the GPS time. The fine time assistance part 21 is furthermore connected to the RBS 19 and has therefore knowledge about the system time of the communications system, e.g. the cellular frame reference time. The fine time assistance part 21 can thereby provide the necessary fine time assistance for the mobile terminal, which in this particular embodiment is sent to the RNC for further use.

In another embodiment, also the fine time assistance part 21 may be separated from the RBS 19 position. In such a case, the fine time assistance part 21 has to be provided with an antenna system that can be listening on the radio signals of the communications system and thereby determine the cellular frame time reference. If the separation between the RBS 19 and the fine time assistance part 21 is significant, such a measured cellular frame time reference has to be compensated for the travelling time between the RBS 19 and the fine time assistance part 21.

It is even possible to use another mobile terminal as the fine time assistance part 21 of the satellite reference node 18. If this mobile terminal is locked to the satellite positioning system and has a well established position as well as a correct satellite reference time, GPS time is readily available and can be distributed to other mobile terminals as assistance data. However, if the satellite reference node 18 is mobile, particular care has to be taken to correct for any distance offsets regarding the position of the satellite reference node 18 relative the radio base station 19 site.

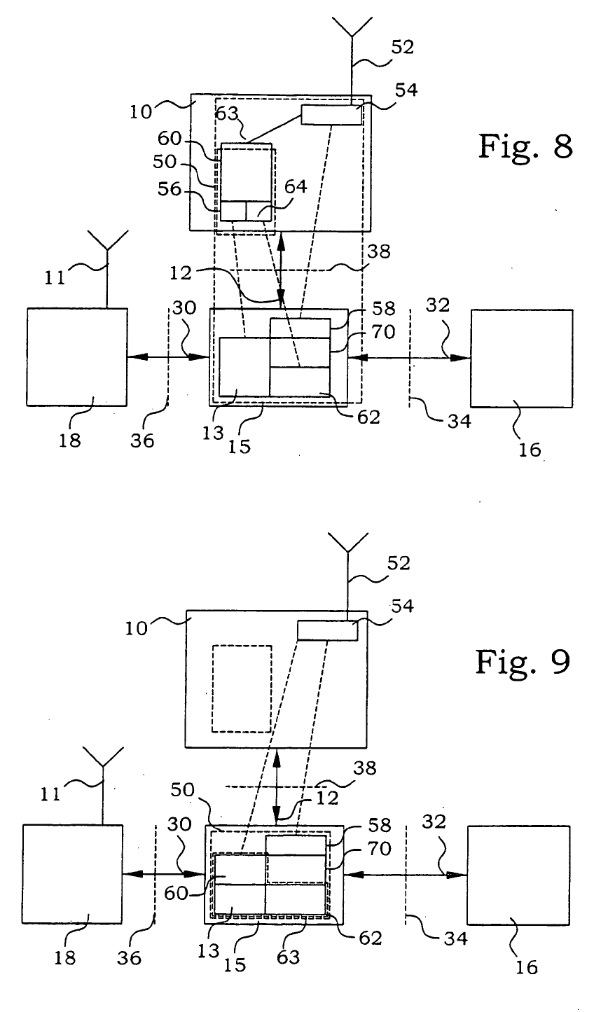

In FIG. 8, another embodiment of a position determining arrangement according to the present invention is illustrated. The mobile terminal 10 is also in this embodiment provided with data necessary for making a search window optimisation, and the actual optimisation is still performed in the processor 60 in the mobile terminal 10. The arrangement 63 for assisting in determining the position for the mobile terminal 10 is also here comprised in the mobile terminal 10 itself. However, in this embodiment, the registered satellite ranging signals are communicated back to the RNC 15 before being extensively processed. A registered satellite ranging signal receiver unit 58 is instead provided in the RNC 15 for handling data concerning registered ranging signals. The actual positioning unit 70 is subsequently also provided in the RNC 15. A positioning node 50 can thus in this embodiment being seen as a node distributed between the RNC 15 and the mobile terminal 10.

The split configuration of the reference satellite node 18 as described in connection with FIG. 7B as well as the alternative embodiments are also applicable to the system described in FIG. 8.

In FIG. 9, an embodiment of a position determining arrangement according to the present invention of a mobile terminal assisted A-GPS type is illustrated. The satellite assistance data available in the RNC 15 is now processed in a processor 60 in the RNC 15. The satellite ranging signal registering unit 54 is then just provided with data defining the optimum search window. The positioning node 50 can now be considered as being comprised within the RNC 15. In this particular embodiment, the RNC 15 comprises the arrangement 63 for assisting in determining a position for a mobile terminal. In this embodiment, the arrangement 63 comprises the satellite positioning assistance unit 13, the processor 60 and the initial positioning unit 62. In an alternative embodiment, where the actual initial positioning is performed elsewhere, the arrangement 63 instead comprises a coarse position receiver unit.

The split configuration of the reference satellite node 18 as described in connection with FIG. 7B as well as the alternative embodiments are also applicable to the system described in FIG. 9.

It is of course also possible to have parts of the arrangement for position determination situated within other nodes of the mobile communications system, either entirely or in a distributed manner. The RNC implementation in the embodiments described above should only be regarded as a non-limiting example of where the parts could be arranged.

In the embodiments above, it is implicitly assumed that the data that is transferred forth and back between the communications network and the mobile terminal utilises different types of control signalling, i.e. the data is transferred at a control plane of the communications network. However, there are also alternative ways for communicating data. The data may e.g. be communicated as data packets, i.e. as unspecified bit streams, at a user plane of the wireless communications system. This may be even more attractive if the satellite reference node and/or parts of the positioning system are more separated from the actual communications network.

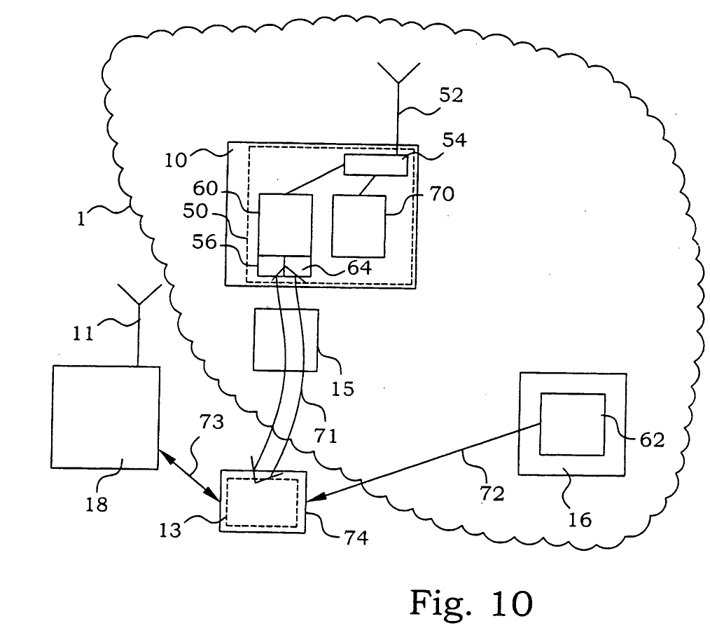

FIG. 10 illustrates an embodiment of a position determining arrangement according to the present invention where the satellite reference node 18 is connected 73 to an “external” assistance node 74. The satellite reference node 18 is here provided with an antenna being able to record radio signals used in the communications system in order to monitor the cellular frame time reference and thereby being able to provide a satellite time reference, in a similar way as discussed further above. In this case, assistance data concerning the satellites are provided by the external assistance node 74 in ordinary data blocks and sent as a data bit stream 71 over the wireless communications network 1 to the mobile terminal 10. In this embodiment, the assistance data receiver unit 56 receives the data packet and extracts the assistance data. The wireless communications network 1 is in this embodiment not involved in processing the assistance data at all. The initial positioning unit 62 could still be situated e.g. in the core network 16 of the communications system 1, providing suitable data to the external assistance node 74 over a link 72 for further use in the mobile terminal 10.

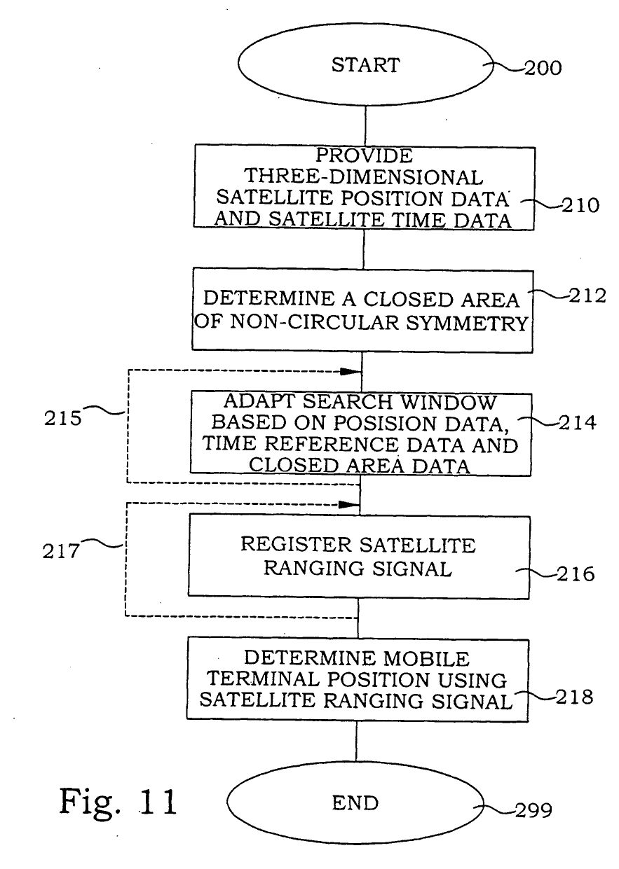

The main steps of an embodiment of a method according to the present invention is illustrated in a flow diagram in FIG. 11. The procedure starts in step 200. In step 210, three-dimensional satellite position data and satellite time reference data is provided. The data can e.g. be provided in the form of satellite ephemeris data or as actual satellite positions in three dimensions for a particular time instant and for certain satellites. In step 212, a non-circular symmetric closed area is determined, within which the mobile terminal is known to be present. The closed area can be determined e.g. by receiving polygonal cell boundary coordinates. A search window for finding the actual code phase of a specific satellite is adapted in step 214 to be as narrow as possible, utilising three-dimensional satellite position data, the satellite time reference data and the data defining the closed area. In a particular embodiment, the search window is minimised among test points situated at the boundary of the closed area and/or at a radio base station site. Since more than one satellite generally is used for positioning purposes step 214 is repeated for each individual satellite, as indicated by the broken arrow 215. In step 216, a satellite ranging signal is registered, using the optimised search window. Also here, since more than one satellite generally is used for positioning purposes step 216 is repeated for each individual satellite, as indicated by the broken arrow 217. Finally, in step 218, a position of the mobile terminal is determined using the registered satellite ranging signal. The procedure ends in step 299.

The basic idea of the invention is to compute optimally small satellite code search windows, for use in the code and Doppler search step of the detection of satellite signals in satellite ranging signal receivers. This is achieved by accounting for the detailed geometry, e.g. the cell polygon, of the region were the terminal is known to be located when positioning is started. Furthermore, the exact 3D locations of all satellites are accounted for. The result is an optimally small code search window, for each individual satellite.

More specifically, the invention relates to the determination of assistance data in the cellular communication system, that is required to provide the satellite signal receivers in mobile terminals with so called fine time assistance. Briefly, fine time assistance means that the satellite signal receiver is provided with highly accurate information related to the global satellite system time and satellite positions in space. Together with the assistance data, upper and lower bounds on the code phases of signals transmitted from all satellites can be computed for terminals that reside anywhere in the region obtained by the initial positioning step. This follows since the times of transmission of the signals from the satellites are synchronised with extreme precision, and since the orbits of these satellites can be calculated in the cellular communication system using other types of assistance data obtained from reference receivers.

The embodiments described above are to be understood as a few illustrative examples of the present invention. It will be understood by those skilled in the art that various modifications, combinations and changes may be made to the embodiments without departing from the scope of the present invention. In particular, different part solutions in the different embodiments can be combined in other configurations, where technically possible. The scope of the present invention is, however, defined by the appended claims.

### Appendix 1

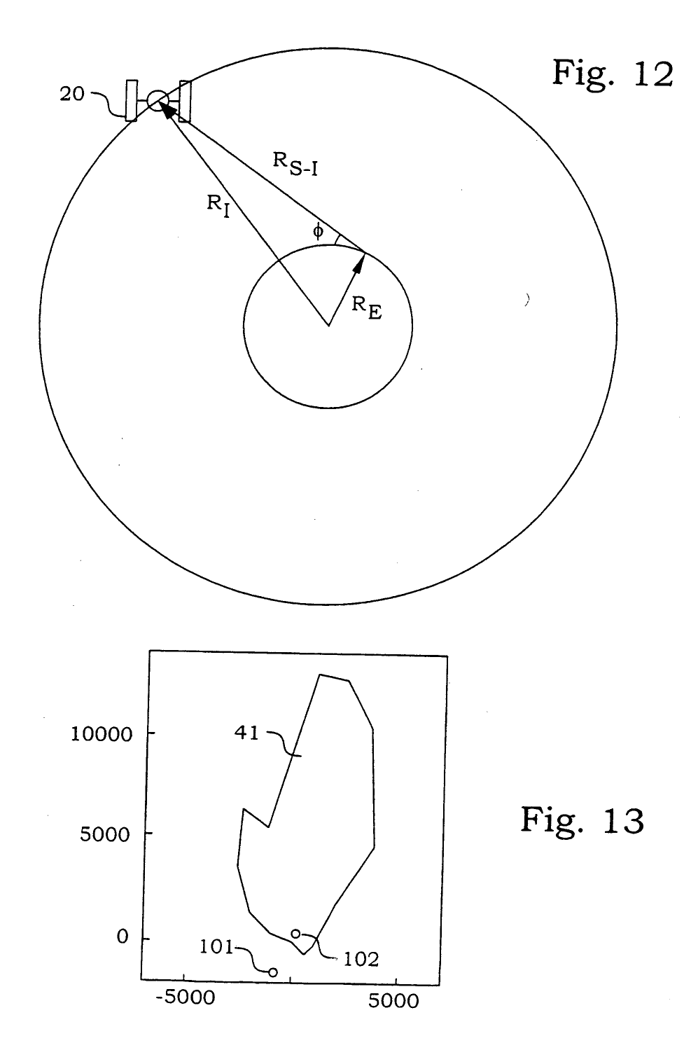

The purpose of the example below is to illustrate the gains that may be achieved by the present invention. The calculations of this example are based on the geometry of FIG. 12.

The intention is to illustrate the variation of the search window size as a function of both the azimuth and elevation of the satellite, for a specific cell polygon and for one interior and one exterior site location. Noting that the distance from the origin of the earth tangential coordinate system to the satellite is the only unknown distance it needs to be solved for. This can be done starting with the vector relation

R₁=R_{ε}+R_{S-1}

Taking the dot product of this equation with itself and exploiting the geometry results in

R₁²=R_{E}²+R_{S-1}²+2RR_{S-1} sin(α).

Solving for the unknown results in

R_{S-1}=−R_{E} sin(α)±\sqrt{R₁²−R² cos²(α)}

where only the positive sign applies. Using R_{S-1} the following vector to the satellite results in the earth tangential coordinate system

rᵢ=(R_{S-1} cos(α)cos(β)R_{S-1} cos(α)sin(β)R_{S-1} sin(α))^{r},

where β denotes the azimuth.

Note: This corresponds to an east-north-up coordinate system.

The corresponding site coordinates are

rₛ=(xₛ yₛ 0)^{r},

while the cell polygon coordinates are

rₑᵢ=(x_{ci} y_{ci} 0)^{T}, i=1, . . . , N.

All needed quantities are now at hand for the evaluation.

A rural cell is treated. The test points are selected as the corners of the rural cell polygon in this part of the example. The numerical quantities of Table 1 were used:

TABLE 1
All quantities are in SI units.

| Quantity | Value |
|---|---|
| r_{c1} | (0 0 0)^{τ} _{[m]} |
| r_{c2} | (−1000 400 0)^{τ} _{[m]} |
| r_{c3} | (−2000 1400 0)^{τ} _{[m]} |
| r_{c4} | (−2600 3600 0)^{τ} _{[m]} |
| r_{c5} | (−2400 6400 0)^{τ} _{[m]} |
| r_{c6} | (−1200 5500 0)^{τ} _{[m]} |
| r_{c7} | (1000 13000 0)^{τ} _{[m]} |
| r_{c8} | (2400 12700 0)^{τ} _{[m]} |
| r_{c9} | (3600 10400 0)^{τ} _{[m]} |
| r_{c10} | (3800 4600 0)^{τ} _{[m]} |
| r_{c11} | (2000 1800 0)^{τ} _{[m]} |
| r_{c12} | (1000 −200 0)^{τ} _{[m]} |
| r_{c13} | (600 −600 0)^{τ} _{[m]} |
| R_{E} | 6378000 [m] |
| R₁ | 26560000 [m] |
| c | 300000000 [m/s] |
| δ | 0.000010 [s] |
| Φ_{GPS} | 1023000 [Hz] |
| rₛ (interior) | (200 400 0)^{τ} _{[m]} |
| rₛ (exterior) | (−800 −1500 0)^{τ} [m] |

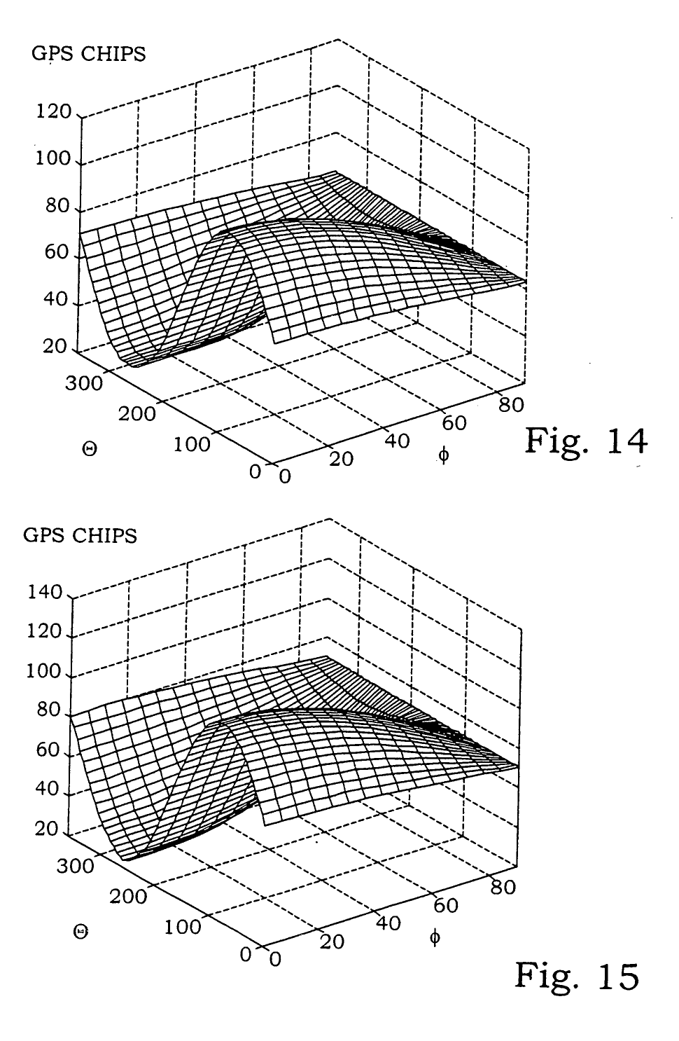

The cell polygon and the site positions are plotted in FIG. 13. The resulting search windows as a function of azimuth and elevation are plotted in FIG. 14 and in FIG. 15.

Some comments are in order.

When the elevation approaches 90 degrees the search window size becomes constant as a function of the azimuth as it should.

The maximum search window size occurs when the main cell area is between the site and the satellite in azimuth. This follows since then the radio signals of the cellular communication system and the radio signals from the GPS satellite meet, thereby maximising the code phase mismatch within the cell area. The GPS reference time is taken in the radio base station site.

The minimum search window size occurs when the site is between the GPS satellite and the main cell area. This follows since then the radio signals of the cellular communication system and the radio signals from the GPS satellite travel in approximately the same direction, thereby minimising the code phase mismatch within the cell area.

The maximum and minimum search windows occur for low elevations. The reason is that the GPS radio signal in such a case travels almost parallel to the surface of the earth.

The behaviour is similar for interior as well as exterior sites.

From the figures above it is clear that the required search window size for large ranges of satellite azimuth and elevation allow far smaller search windows than what is required when existing technology is used. With most prior-art methods, the maximum search window size needs to be used for all satellite positions. In order to assess the gains, the average search window size computed from the FIGS. 14 and 15 can be compared to the maximum search window sizes of those figures. Note that care needs to be exercised in the calculation. The reason is that the distribution of satellites must be assumed to be uniform with respect to the area of the sky. This implies that the distribution is uniform with respect to the azimuth angle. It is however not uniform with respect to the elevation angle since smaller areas of the sky are covered by equal (small) elevation angle intervals when the elevation angle becomes higher. The probability distribution function can be calculated as follows, by considering the differential area covered at an elevation angle a at a test range r. This is given by:

dA(α)=diameter×height=2πr cos(α)×rdα.

Dividing with the area of a half sphere, it is clear that the distribution can be written as:

f_{α,β}(α,β)=C cos(α).

The constant can be determined by the normalising relation:

$$1 = {\int }_{0}^{2 π} {\int }_{0}^{\frac{π}{2}} C cos ( α ) d α d β = 2 π C .$$

The formula for calculation of the expectation of the search window size hence becomes:

$$\begin{matrix}E [ Window ] = \frac{1}{2 π} {\int }_{0}^{2 π} {\int }_{0}^{\frac{π}{2}} cos ( α ) Window ( α , β ) d α d β \\ \approx \frac{1}{2 π} {\sum }_{i = 1}^{K} {\sum }_{j = 1}^{L} cos ( {α}_{j} ) Window ( {α}_{j} , {β}_{i} ) ΔαΔβ .\end{matrix}$$

Here Window(α,β) is the quantity displayed in FIG. 14 and 15. Δα and Δβ denote the elevation and azimuth spacing in radians between the grid points in these plots.

Using the formula for the expectation the following values were calculated for each of the figures and they are displayed in Table 3.

TABLE 3
Mean and max values of the required GPS code search window size.

| | Mean window | Max Window size | Average |
|---|---|---|---|
| FIG. | size [GPS chips] | [GPS chips] | reduction |
| FIG. 14 | 69.6 | 106.5 | 35% |
| FIG. 15 | 76.8 | 120.1 | 36% |

Obviously, A-GPS complexity can be reduced by more than ⅓ by the procedure of the invention. This translates into an extended battery life and/or a reduced computation time. Equivalently, for constant correlation resources, the correlation time can be increased by a factor of 1.5, this being equivalent to an A-GPS sensitivity gain of 10¹⁰log(1.5)≈2 dB.

### Apendix 2

This is a proof of the fact that only points on the polygon boundary are relevant in the determination of the maximum limit of the search window.

First note that the first term of ΔΦ is independent of the terminal position. It is constant in each case since a time stamp is only determined once for each positioning. The consequence is that only the second and third terms need to be considered in the maximisation and minimisation.

Now assume the contrary to the results, i.e. that the maximum value is attained for an interior point of the polygon. Then, by the topological definition of an interior point, there is a neighbourhood around this point that is also interior to the cell polygon. The maximum value of the phase difference can then be made larger than the assumed maximum, by moving in a suitable direction within the neighbourhood. All directions are possible since movement in an open neighbourhood is considered. First, movement along a circle of constant distance to the site, in the direction that increases the value of the third term of ΔΦ is performed, noting that the second term remains constant on the circle, and a contradiction is obtained.

In case the terminal position would be exactly on the line, projected onto the horizontal plane of the earth tangential coordinate system, between the site and the satellite, the assumed maximum value can instead be increased by moving straight towards the satellite. This follows since the radio signals from the GPS satellites and the serving radio base station site both travel with the same speed c. Furthermore, the elevation angle of the GPS satellite is strictly larger than zero. Hence the difference in travel distance of GPS signals to the interior point on one hand and the boundary of the neighbourhood towards which movement is considered on the other hand, must be smaller than the corresponding travel distance along the surface of the earth that is experienced by the radio signals from the serving radio base station. Hence the experienced code phase advance due to the second term of ΔΦ will be larger than the code phase reduction due to the third term of ΔΦ. The overall effect is a code phase advance and a contradiction is again obtained.

In case the site is between the terminal and the satellite, the maximum value also increases when the terminal moves away from the site along the projected line between the site and the satellite. Both the second and the third terms then contribute to the code phase advance with the same sign. A contradiction is obtained again. Obviously the above argument still hold in case the radio base station site is located outside the cell polygon. It can hence be concluded that the assumption that the maximum code phase is attained in an interior point is false. Hence

$${max}_{{r}_{t}} ΔΦ$$

is always attained at the boundary of the cell polygon.

This is a proof of the fact that only points on the polygon boundary or at the radio base station site are relevant in the determination of the minimum limit of the search window.

Since the elevation angles of the GPS satellites are strictly greater than zero, it follows that the phase advance introduced by the second term of ΔΦ is greater than any phase retardation caused by the third term, for all tentative terminal positions r₁. Hence, in case the serving radio base station site is located in the interior of the cell polygon, the minimum phase difference is attained when the terminal is located in the same coordinates as the serving radio base station site.

In case the serving radio base station site is located outside the cell polygon, then there exist a point on the boundary where ΔΦ attains a minimum value. The boundary is a compact set and ΔΦ is a continuous function. This can as above be proved by assuming the contrary, i.e. that the minimum value of ΔΦ is attained in the interior of the cell polygon. Then by following a circle around the site, ΔΦ can be reduced by moving in one of the two possible directions unless the interior point is located exactly on the projected line segment between the serving radio base station site and the satellite. Since the travel distance differences for GPS signals between points on the surface are less than for radio signals that travel along the surface, it follows that ΔΦ can be reduced by moving towards the radio base station site. A contradiction has thus been obtained and it is clear that minΔΦ is located on the boundary of the cell polygon in case the serving radio base station site is located outside the cell polygon.

### REFERENCES

[1] E. D. Kaplan (ed.), Understanding GPS—Principles and Applications. Norwood, Mass.: Artech House, 1996, pp. 1-9.

0[2] E. D. Kaplan (ed.), Understanding GPS—Principles and Applications. Norwood, Mass.: Artech House, 1996, pp. 119-120.
[3] E. D. Kaplan (ed.), Understanding GPS—Principles and Applications. Norwood, Mass.: Artech House, 1996, pp. 27-39.
[4] 3GPP TS 25.453, vers. 5.0.0, sections 1-3.
[5] E. D. Kaplan (ed.), Understanding GPS—Principles and Applications. Norwood, Mass.: Artech House, 1996, pp. 15-23.
[6] U.S. Pat. No. 6,429,815.

1. A method for use when determining a position of a mobile terminal being connected to a wireless communications network via a base station, comprising the steps of:
providing satellite position data and satellite time reference data;
the satellite position data comprising three-dimensional satellite position data;
determining a closed area, within which the mobile terminal is situated;
the closed area having a non-circular symmetry with respect to the base station; and
adapting a search window to a specific satellite from which a satellite ranging signal emerges;
the step of adapting comprising minimisation of a width of the search window by determining an optimum search window lower limit and an optimum search window upper limit based on the three-dimensional satellite position data, the satellite time reference data and the data defining the closed area;
the closed area is limited only by linear boundary portions between closed area corners, whereby only points on the linear boundary portions and the closed area corners are relevant for determination of the optimum search window upper limit.

2. A method according to claim 1 comprising the further steps of:
registering a satellite ranging signal, using the adapted search window; and
determining a position of the mobile terminal using the registered satellite ranging signal.

3. A method according to claim 1, comprising the further steps of:
selecting at least two points at a boundary of the closed area; and
estimating code phase shifts of the at least two points for the satellite ranging signal to be registered;
whereby the search window upper limit is determined to be equal to the largest one of the estimated code phase shifts of the at least two points plus an uncertainty of the satellite time reference data.

4. A method according to claim 3, wherein the closed area corners are selected as the at least two points.

5. A method according to claim 3, wherein the base station is located within the closed area, whereby the search window lower limit is determined to be equal to an estimated code phase shift for the satellite ranging signal to be registered at the base station location minus an uncertainty of the satellite time reference data.

6. A method according to claim 3, wherein the base station is located exterior to the closed area, whereby the search window lower limit is determined to be equal to the smallest one of the estimated code phase shifts of the at least two points minus the uncertainty of the satellite time reference data.

7. A method according to claim 3, wherein the code phase shift is estimated by:
Φ=Φ_{CP}+Φ_{SP},
where Φ is the estimated code phase shift, Φ_{CP} is a code phase shift caused by wireless propagation of data signal between the base station and the mobile terminal, and Φ_{SP} is a code phase shift caused by a difference in signal propagation between the satellite and the mobile terminal and signal propagation between the satellite and the base station.

8. A method according to claim 7, wherein the code phase shift Φ_{Cp} is computed as:
$${Φ}_{SP} = \frac{1}{c} ‖ \underline{{r}_{t}} - \underline{{r}_{s}} ‖ {R}_{cc} ,$$
where c is the speed of light, r₁ the location of the point for which the estimation is computed, rₛ is the location where the satellite time reference data is provided, R_{cc} is the code chip rate used by the satellite, and ∥ ∥ denotes the Euclidean length of a vector.

9. A method according to claim 7, wherein the code phase shift Φ_{SP} is computed as:
$${Φ}_{CP} = \frac{1}{c} ( ‖ \underline{{r}_{i}} - \underline{{r}_{s}} ‖ - ‖ \underline{{r}_{i}} - \underline{{r}_{t}} ‖ ) {R}_{cc} ,$$
where c is the speed of light, rᵢ the location of the satellite, rᵢ the location of the point for which the estimation is computed, rₛ is the location where the satellite time reference data is provided, R_{cc} is the code chip rate used by the satellite, and ∥ ∥ denotes the Euclidean length of a vector.

10. A method according to claim 1, wherein the mobile terminal is connected to a communications system operating by frames, whereby the satellite time reference data comprises relative time reference to a time reference of the communications system.

11. A method according to claim 1, wherein the step of providing satellite time reference data comprises registering of a satellite ranging signal at the position of the base station.

12. A method according to claim 1, wherein the step of providing satellite time reference data comprises registering of a satellite ranging signal at a known position separate from the position of the base station and recalculation of the satellite time reference data as if registering would have been performed at the position of the base station.

13. A method according to claim 1, wherein the satellite position data and the satellite time reference data are provided at different positions.

14. A method according to claim 1, wherein the satellite is a Global Positioning System satellite.

15. An arrangement for use in determining a position of a mobile terminal being connected to a wireless communications network via a base station, the arrangement comprising:
means for providing satellite position data and satellite time reference data;
the means for providing satellite position data being arranged to provide three-dimensional satellite position data;
coarse positioning means for determining a closed area, within which the mobile terminal is situated;
the closed area having a non-circular symmetry with respect to the base station; and
means for adapting a width of a search window to a specific satellite from which a satellite ranging signal emerges;
the means for adapting being arranged to determine an optimum search window lower limit and an optimum search window upper limit based on the three-dimensional satellite position data, the satellite time reference data and data defining to the closed area;
the closed area is limited by only linear boundary portions between closed area corners, whereby only points on the boundary portions and the closed area corners are relevant for determination of the optimum search window upper limit.

16. An arrangement according to claim 15 wherein the means for adapting is arranged for selecting at least two points at a boundary of the closed area, estimating code phase shifts of the at least two points, and determine the search window upper limit to be equal to the largest one of the estimated code phase shifts of the at least two points plus an uncertainty of the satellite time reference data.

17. An arrangement according to claim 16, wherein the closed area corners are selected as the at least two points.

18. An arrangement according to claim 16, wherein the base station is located within the closed area, whereby the means for adapting is arranged for determining the search window lower limit to be equal to an estimated code phase shift at the base station location minus an uncertainty of the satellite time reference data.

19. An arrangement according to claim 16, wherein the base station is located exterior to the closed area, whereby the means for adapting is arranged for determining the search window lower limit to be equal to the smallest one of the estimated code phase shifts of the at least two points minus the uncertainty of the satellite time reference data.

20. An arrangement according to claim 15, wherein the wireless communications system operates by transmitting data frames.

21. An arrangement according to claim 15, wherein the satellite is a Global Positioning System satellite.

22. An arrangement according to claim 15, further comprising:
means for handling data concerning registering of the satellite ranging signal using the adapted search window; and
means for determining a position of the mobile terminal using the satellite ranging signal.

23. A mobile terminal comprising an arrangement for use in determining a 1position of said mobile terminal when being connected to a wireless communications network via a base station;
the arrangement in turn comprising:
means for providing satellite position data and satellite time reference data;
the means for providing satellite position data being arranged to provide three-dimensional satellite position data;
coarse positioning means for determining a closed area, within which the mobile terminal is situated;
the closed area having a non-circular symmetry with respect to the base station; and
means for adapting a width of a search window to a specific satellite from which a satellite ranging signal emerges;
the means for adapting being arranged to determine an optimum search window lower limit and an optimum search window upper limit based on the three-dimensional satellite position data, the satellite time reference data and data defining to the closed area;
the closed area is limited by only linear boundary portions between closed area corners, whereby only points on the boundary portions and the closed area corners are relevant for determination of the optimum search window upper limit;
the coarse positioning means comprises a receiver for data, defining the closed; and
the means for providing satellite position data and satellite time reference data comprises a receiver for satellite position data and satellite time reference data provided by a reference node.

24. A mobile terminal according to claim 23, further comprising:
means for handling data concerning registering of the satellite ranging signal, using the adapted search window; and
means for determining a position of the mobile terminal using the satellite ranging signal:
means for handling comprises means for registering the satellite ranging signal.

25. A wireless communications system, comprising:
a mobile terminal having an arrangement for use in determining a position of said mobile terminal;
said arrangement in turn comprising:
means for providing satellite position data and satellite time reference data:
the means for providing satellite position data being arranged to provide three-dimensional satellite position data;
coarse positioning means for determining a closed area, within which the mobile terminal is situated:
the closed area having a non-circular symmetry with respect to the base station; and
means for adapting a width of a search window to a specific satellite from which a satellite ranging signal emerges;
the means for adapting being arranged to determine an optimum search window lower limit and an optimum search window upper limit based on the three-dimensional satellite position data, the satellite time reference data and data defining to the closed area,
the closed area is limited by only linear boundary portions between closed area corners, whereby only points on the boundary portions and the closed area corners are relevant for determination of the optimum search window upper limit;
the coarse positioning means comprises a receiver for data, defining the closed area; and
the means for providing satellite position data and satellite time reference data comprises a receiver for satellite position data and satellite time reference data provided by a reference node;
said wireless communications system further comprises:
means for handling data concerning registering of the satellite ranging signal using the adapted search window; and
means for determining a position of the mobile terminal using the satellite ranging signal.

26. A wireless communications system according to claim 25, wherein the means for determining is situated in a mobile communications system node, and the means for handling comprises a receiver for data related to a satellite ranging signal registered in the mobile terminal.

27. A wireless communications system according to claim 25, wherein said means for handling data concerning registering of the satellite ranging signal and said means for determining a position of the mobile terminal using the satellite ranging signal are comprised in said mobile terminal.

28. A wireless communications system according to claims 25, wherein the satellite position data and satellite time reference data is communicated by control signalling in the wireless communications system.

29. A wireless communications system according to claim 25, wherein the satellite position data and satellite time reference data is communicated as data packets over a user plane of the wireless communications system.

30. A wireless communications system node comprising an arrangement for use in determining a position of a mobile terminal being connected to a wireless communications network via a base station;
the arrangement in turn comprising:
means for providing satellite position data and satellite time reference data;
the means for providing satellite position data being arranged to provide three-dimensional satellite position data;
coarse positioning means for determining a closed area, within which the mobile terminal is situated;
the closed area having a non-circular symmetry with respect to the base station; and
means for adapting a width of a search window to a specific satellite from which a satellite ranging signal emerges;
the means for adapting being arranged to determine an optimum search window lower limit and an optimum search window upper limit based on the three-dimensional satellite position data, the satellite time reference data and data defining to the closed area;
the closed area is limited by only linear boundary portions between closed area corners, whereby only points on the boundary portions and the closed area corners are relevant for determination of the optimum search window upper limit.

31. A wireless communications system node according to claim 30, wherein the means for providing satellite position data and satellite time reference data comprises a receiver for satellite position data and satellite time reference data provided by a reference node.

32. A wireless communications system node according to claim 31, wherein the reference node comprises a fine time assistance part and a satellite position assistance part, located at different positions.

33. A wireless communications system node according to claim 31, wherein at least a part of the reference node is located in connection with the radio base station.

34. A wireless communications system node according to claims 30, wherein the coarse positioning means comprises mean for determining a cell area of the wireless communications system in which the mobile terminal is connected.

35. A wireless communications system node according to claim 30, wherein the means for determining the closed area comprises mean for measuring time propagation times between the mobile terminal and the base station.

36. A wireless communications system according to claim 25, wherein the wireless communications system is a system selected from the list of:
a WCDMA system;
a CDMA-2000 system;
a GSM system.

37. A wireless communications system comprising: a wireless communications system node having an arrangement for use in determining a position of a mobile terminal connected to said wireless communications system;
said arrangement in turn comprising:
means for providing satellite position data and satellite time reference data;
the means for providing satellite position data being arranged to provide three-dimensional satellite position data;
coarse positioning means for determining a closed area, within which the mobile terminal is situated;
the closed area having a non-circular symmetry with respect to the base station; and
means for adapting a width of a search window to a specific satellite from which a satellite ranging signal emerges;
the means for adapting being arranged to determine an optimum search window lower limit and an optimum search window upper limit based on the three-dimensional satellite position data, the satellite time reference data and data defining to the closed area;
the closed area is limited by only linear boundary portions between closed area corners, whereby only points on the boundary portions and the closed area corners are relevant for determination of the optimum search window upper limit;
the coarse positioning means comprises a receiver for data, defining the closed area; and
the means for providing satellite position data and satellite time reference data comprises a receiver for satellite position data and satellite time reference data provided by a reference node;
said wireless communications system being a system selected from the list of:
a WCDMA system;
a CDMA-2000 system;
a GSM system.
